(19) United States
(12) Patent Application Publication
(10) Pub. No.: US 2012/0070812 A1
(43) Pub. Date: Mar. 22, 2012

(54) DEVICE FOR SIMULATING CARDIO-PULMONARY RESUSCITATION TECHNIQUES

(75) Inventor: Raul Vicedo Peinado, IBI (Alicante) (ES)

(73) Assignee: ENFAVI, S.L., IBI (Alcante) (ES)

(21) Appl. No.: 13/322,703

(22) PCT Filed: Apr. 30, 2010
(86) PCT No.: PCT/ES2010/070277

§ 371 Date: Nov. 28, 2011

(30) Foreign Application Priority Data
May 28, 2009 (ES) P200930216
Oct. 14, 2009 (ES) P200930843

(51) Int. Cl. G09B 23/32

(52) U.S. Cl. 434/265

(57) ABSTRACT

A device for simulating cardiopulmonary resuscitation techniques including a base coupled to a chest piece in the shape of a human thorax and designed to be elastically deformed towards the base when pressure is placed thereon by a user, where an upper end of the base is articulated to a head piece, the device including a pressure adjustment piece located in a central area of the base designed to occupy a first position in which an upper height stop limits the deformation of the chest piece when pressure is placed thereon, a second position, in which a lower height stop limits the deformation of the chest piece, the limit deformation of the chest piece in the second position being greater than the limit deformation in the first position, and a third position, in which the deformation of the chest piece is not limited.

### TECHNICAL FIELD

The present invention relates to a device for simulating cardiopulmonary resuscitation techniques applicable in healthcare and more specifically in any educational activity involving teaching and/or practicing said cardiopulmonary resuscitation techniques without patients, allowing learning and improving them comfortably without the risk that their learning with people entails, while at the same time achieving a realistic simulation of the response which would be given by a real patient.

### BACKGROUND

Cardiopulmonary resuscitation techniques require qualified personnel to practice a thoracic massage in combination with insufflations on a patient experiencing cardio-respiratory arrest. Said emergency situations occur both in hospital environments and in accidents, for example, road accidents, in which urgent intervention is required and healthcare or qualified personnel dominating said techniques is needed, given that a failed actuation in performing said resuscitation techniques may have fatal consequences.

Therefore special training both in theoretical and in practical aspects is required in performing said resuscitation techniques so that in view of critical situations in which performing resuscitation is necessary, the qualified personnel has practiced the necessary maneuvers enough to the point of being well-versed in the movements, performing them mechanically.

Currently, real size dummies are used to practice these techniques in which the movements and the mouth-to-mouth breathing techniques are simulated even though said dummies have many limitations and differences with the response given by a real patient since they do not allow simulating the thoracic movements or the breathing of a patient experiencing cardiopulmonary arrest.

### BRIEF SUMMARY

The present invention relates to a device for simulating cardiopulmonary resuscitation techniques which allows teaching and/or practicing said cardiopulmonary resuscitation techniques without patients, allowing learning and improving them comfortably without the risk and the determining factors that their learning with people entails.

The device for simulating cardiopulmonary resuscitation techniques proposed by the invention comprises a base designed to be coupled to a chest piece in the shape of a human thorax and is designed to be elastically deformed towards the base when pressure is placed thereon manually by a user. The term “elastically” is understood as once the pressure ceases the chest piece recovers its original position again.

The base and the chest piece have a coinciding plan projection, a hollow space existing between said base and said chest piece when they are coupled, preferably along their perimeter, simulating a human torso.

An upper end of the base is articulated to a head piece in the partial shape of a human face corresponding to the front area of a human head.

Thus, according to the invention, the device comprises a pressure adjustment piece by way of a rotating wheel which is located in a central area of the base, and more specifically at a height located approximately at the center of the distance between the areas corresponding to the lower part of the neck and the sternum, the plan projection of which further corresponds with the area where pressure is applied for cardiopulmonary resuscitation on the chest piece.

Said pressure adjustment piece is designed to occupy three positions. There is a first position in which at least one upper height stop limits the deformation of the chest piece when pressure is placed thereon. There is a second position in which at least one lower height stop limits the deformation of the chest piece when pressure is placed thereon, the limit deformation of the chest piece in the second position being greater than the limit deformation in the first position. Finally, there is a third position for advanced users in which the deformation of the chest piece is not limited by stops, i.e., the position is free.

Therefore, in view of the aforementioned, in the first and second position, once the stops are contacted, said stops prevent the continued movement of the chest piece when pressure is placed thereon, its deformation being limited to the point defined by the position of said stops.

Thus, when the pressure adjustment piece is in the first position, the device allows simulating cardiopulmonary resuscitation techniques in children, whereas when the pressure adjustment piece is in the second position, the device serves to simulate cardiopulmonary resuscitation techniques in adults.

In short, in the first position, according to a preferred embodiment, when the resuscitation is performed a noise is produced indicating that chest deformation or caving in has reached 3 cm, this being the deformation stop position of the chest piece defined by the upper height stop. On the other hand, the second position is for practicing in adults but for users who are beginners, such that according to a preferred embodiment when the resuscitation is performed a noise is produced indicating that 4.5 cm, which is the stop position defined by the lower height stop, has been reached.

The elements comprised in the device, including the rivets and attachment means, are preferably made of thermoplastic materials, whereby a high dimensional quality is achieved at low cost, in addition to obtaining an extremely lightweight device which allows it be transported easily.

The possibility that the head piece has two nasal orifices and a buccal orifice is contemplated such that the combined actuation on the chest piece, performing a cardiopulmonary massage with insufflations on the orifices allows simulating cardiopulmonary resuscitation techniques with the device, such that the articulation of the head piece with respect to the base allows simulating the neck movements of a patient. Thus, the device comprises a lung-shaped elastic bag, preferably made of plastic, which is housed in the space existing between the base and the chest piece, having a volume comprised between 400-600 ml according to a preferred embodiment of the invention.

The bag is in turn coupled to the orifices by means of a coupling device by way of a funnel which is located in the inner face of the head piece. Said coupling device comprises a valve channeling the entrance of air into the bag from the nasal orifices and the buccal orifice and allows expelling said air from the bag when the cardiopulmonary resuscitation is stopped through an exit path different from said nasal orifices and said buccal orifice, all for hygienic reasons to prevent infections in different uses of the device.

A more realistic simulation is thus achieved because the bag simulates the action of the lungs, so that they are inflated and a correct learning of the cardiac massage is practiced, said bag passing through the area corresponding to the neck, such that as the head piece is articulated with respect to the base, the user of the device is obliged to place the head in its correct position because if it is placed forwards, placing pressure on the neck, the bag is blocked and does not let the air to pass, therefore the user has to move the head backwards so that the air can pass and fill the bag, and perform the artificial or mouth-to-mouth breathing at that time.

It is contemplated that the head piece is designed to occupy a resting position in which it is kept substantially horizontal, i.e., in straight line, and the entrance of air into the bag through the orifices is prevented by a ball comprised in the valve, and an active position for the cardiopulmonary resuscitation in which the head piece is inclined backwards and the ball of the valve allows the entrance of air into the bag through said orifices.

The user of the device is thus obliged to place the head in its correct position because if it is placed forwards, the entrance of air into the bag is blocked and it does not let the air pass, therefore the user has to move the head backwards so that the air can pass and fill the bag, and perform the artificial or mouth-to-mouth breathing at that time.

Likewise it is contemplated that the device comprises actuation means which permanently act on the head piece, tending to move and keep said head piece in the resting position when the actuation from a user is not received, thus allowing the head piece to return to the initial position when the user releases it, therefore to perform cardiopulmonary resuscitation the user has to keep said head piece inclined manually, as is required at the time of performing this technique with a real patient.

Finally, it is contemplated that the head piece comprises a closing wall located as lower prolongation preventing the access to the inside of the head piece from the area of the neck corresponding to the area of the chest piece. The cavity of the neck is thus closed, preventing being able to introduce fingers and preventing cuts or accidents from occurring as a consequence of manipulating said area.

Likewise, it is contemplated that the device comprises a compression spring designed to oppose resistance when pressure is exerted on the chest piece when it is brought closer to the base, and contributes to recovering the position of said chest piece when said pressure is removed.

The arrangement of the compression spring allows the recovery of the chest to be complete and to be similar to reality. The spring is located at the plan height where pressure is applied for cardiopulmonary resuscitation, exerting a certain pressure, such that it provides the feeling of practicing cardiopulmonary recovery on a person. The compression spring allows preventing successive deformations of the chest piece, which can cause permanent deformation as a consequence of the successive loss of elasticity, if it is made of plastic, whereby prolonging the service life of the device, assuring a correct operation.

Finally it is contemplated that the device comprises a chest protector designed to be interchangeably coupled on the chest piece, and a mask designed to be interchangeably coupled on the head piece, both preferably being made of thermoplastic materials, whereby achieving greater protection of the chest piece and head piece.

The possibility that each upper height stop prolongs into an upper pivot and that each lower height stop prolongs in an upper position into a lower pivot is contemplated, said lower pivot and upper pivot being designed to be alternatively housed in at least one guide prolonging from the inner face of the chest piece. The guides arranged circumferentially in correspondence with the pivots thus allow partially and alternatively housing the pivots of the lower stops or the pivots of the upper stops until the movement of the chest piece is limited when the end of the guides contacts with the corresponding stop. A guided movement, being a gentler movement which better simulates the reaction of a real patient, is thereby achieved in the flexion or deformation of the chest piece when performing the cardiac massage.

Similarly to the guides and the pivots defining the different positions of the device, it is contemplated that a central guide housed in a central pivot of the pressure adjustment piece prolongs from the inner face of the chest piece, said central pivot being kept in the central guide in any position in which said pressure adjustment piece is located. The compression spring is in turn arranged in said central guide.

### BRIEF DESCRIPTION OF THE DRAWINGS

To complement the description that is being made and for the purpose of aiding to better understand the features of the invention according to a preferred practical embodiment thereof, a set of drawings is attached as an integral part of said description in which the following has been depicted with an illustrative and non-limiting character:

FIG. 1 shows a top perspective view of the device for simulating cardiopulmonary resuscitation techniques proposed by the invention.

FIG. 2 shows a bottom perspective view of the device in which both the pressure adjustment piece located in the base and the coupling device located in the inner face of the head piece can be seen.

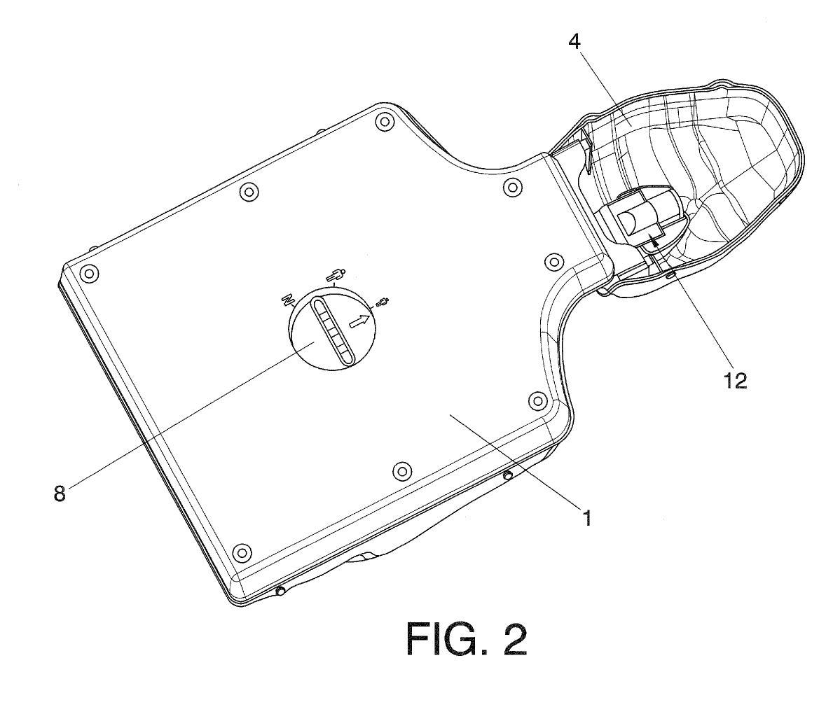

FIG. 3 shows a detail view of FIG. 2 in which the articulation pin between the head piece and the assembly formed by the base and the chest piece as well as the arrangement of the actuation means keeping the head piece in the resting position can be seen.

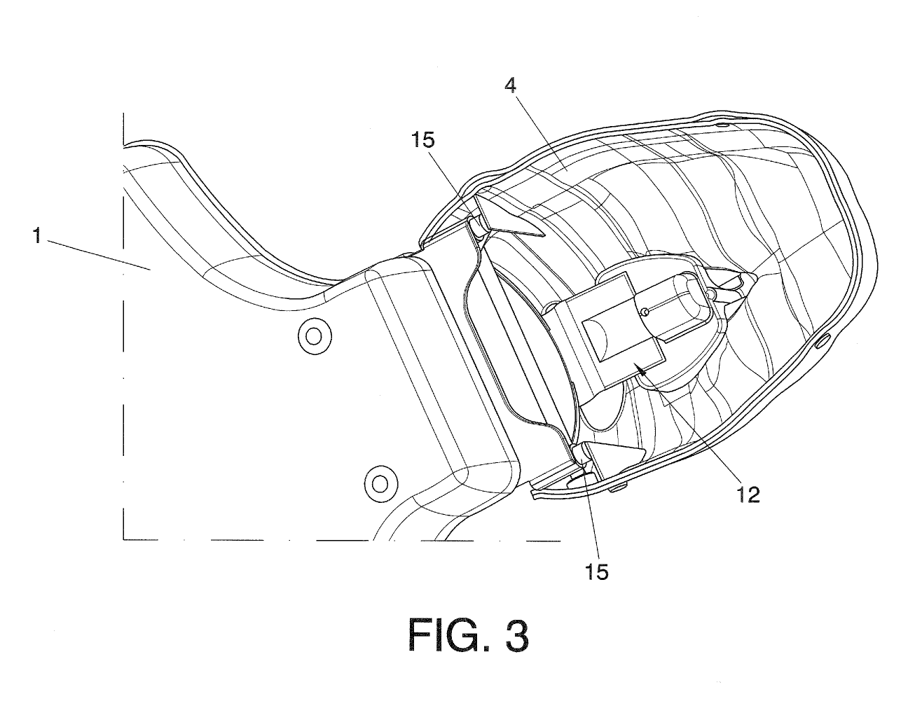

FIG. 4 shows a longitudinal section of the head piece located in the resting position in which the ball of the valve located in a position preventing the passage of air into the bag can be seen.

FIG. 5 shows a perspective view of a detail of a longitudinal section of the valve corresponding to the resting position depicted in FIG. 4.

FIG. 6 shows a longitudinal section of the head piece located in the active position, i.e., inclined backwards, in which the ball of the valve located in a position allowing the passage of air into the bag can be seen.

FIG. 7 shows a perspective view of a detail of a longitudinal section of the valve corresponding to the active position depicted in FIG. 6.

FIG. 8 shows a detail according to a perspective view from a lower viewpoint of the actuation means and the actuation thereof by way of a spring on tabs which are located in the inner face of the head piece, keeping said head piece in the resting position in the depicted position.

FIG. 9 shows a detail view such as that of FIG. 8, where the head piece has been depicted in the active position.

FIG. 10 shows a profile view of the device of the invention, the head piece having being depicted in the active position, inclined backwards, for cardiopulmonary resuscitation.

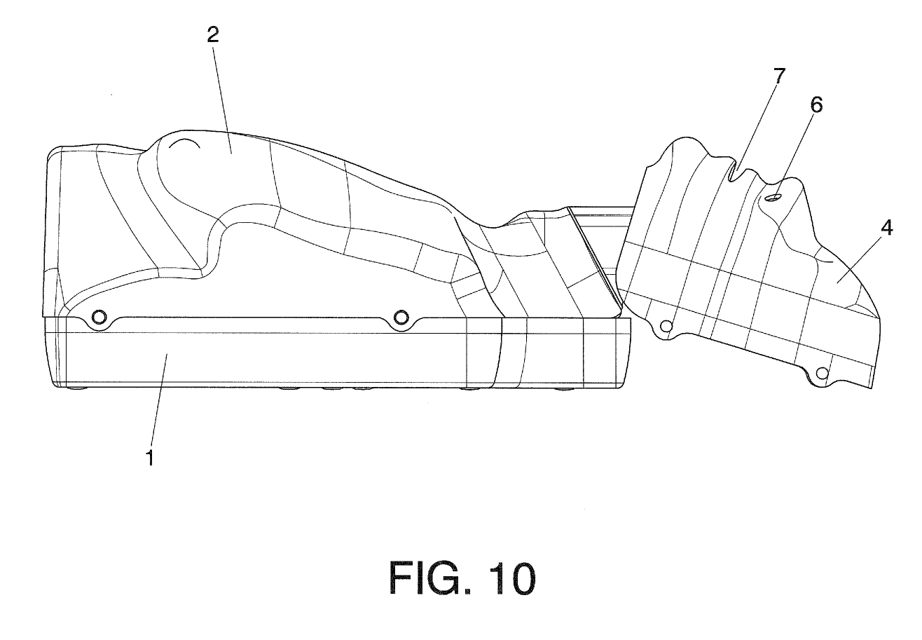

FIG. 11 shows a schematic view of the hollow space existing between the chest piece and the base, in which the pressure adjustment piece can be seen in the first position, the guides of the chest piece being in contact with the upper height stops.

FIG. 12 shows an exploded perspective view of the elements depicted in FIG. 11.

FIG. 13 shows a perspective view of the valve and its passage piece in an intermediate assembly position.

FIG. 14 shows an exploded perspective view of the elements comprised in the valve.

FIG. 15 shows a perspective view of the valve with the passage piece in its assembly position, i.e., inserted into the valve.

### DETAILED DESCRIPTION

In view of the described drawings, it can be seen how in one of the possible embodiments of the invention, the device for simulating cardiopulmonary resuscitation techniques proposed by the invention comprises a base (1) which is coupled to a chest piece (2) in the shape of a human thorax and is designed to be elastically deformed towards the base (1) when pressure is manually placed thereon by a user.

The base (1) and the chest piece (2) have a coinciding plan projection, a hollow space existing between said base (1) and said chest piece (2) when they are coupled, simulating a human torso.

An upper end of the base (1) is articulated to a head piece (4) in the partial shape of a human face.

The device comprises a pressure adjustment piece (8) located in a central area of the base (1) the plan projection of which corresponds with the area where pressure is applied for cardiopulmonary resuscitation, where said pressure adjustment piece (8) is designed to occupy a first position, in which two upper height stops (10) limit the deformation of the chest piece (2) when pressure is placed thereon, a second position, in which two lower height stops (9) limit the deformation of the chest piece (2) when pressure is placed thereon, the limit deformation of the chest piece (2) in said second position being greater than the limit deformation in the first position, and a third position, in which the deformation of the chest piece (2) is not limited by stops.

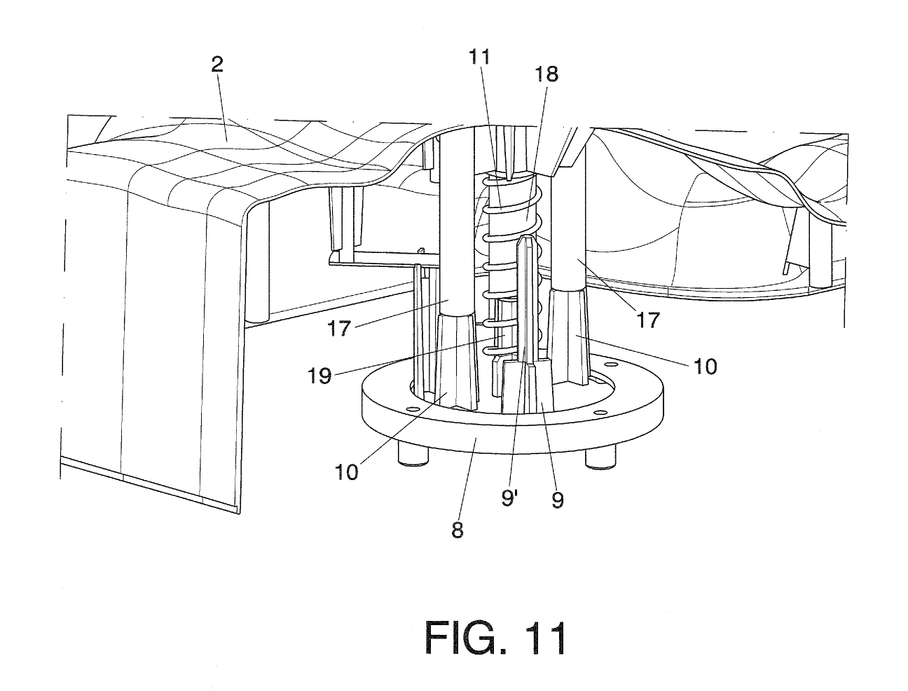

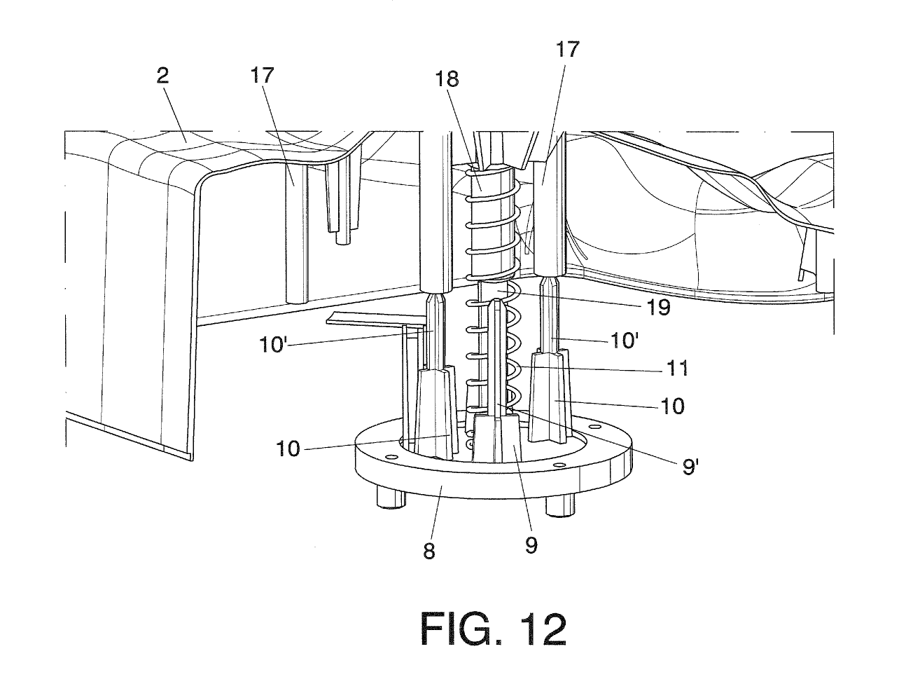

As can be seen in FIGS. 11 and 12 each upper height stop (10) prolongs into an upper pivot (10′) and each lower height stop (9) prolongs into a lower pivot (9′), said lower pivot (9′) and upper pivot (10′) being designed to be alternatively housed in two guides (17) prolonging from the inner face of the chest piece (2).

The arrangement of the central guide (18) and the housing of the central pivot (19) around which there is arranged the compression spring (11) can also be seen in said FIGS. 11 and 12.

The head piece (4) has two nasal orifices (6) and a buccal orifice (7), the device comprising a lung-shaped bag housed in the space existing between the base (1) and the chest piece (2) which is coupled to said orifices (6, 7) by means of a coupling device (12) located in the inner face of the head piece (4).

Said coupling device (12) comprises a valve (13) channeling the entrance of air into the bag from the nasal orifices (6) and the buccal orifice (7) and allows expelling said air from the bag through an exit path different from said nasal orifices (6) and said buccal orifice (7).

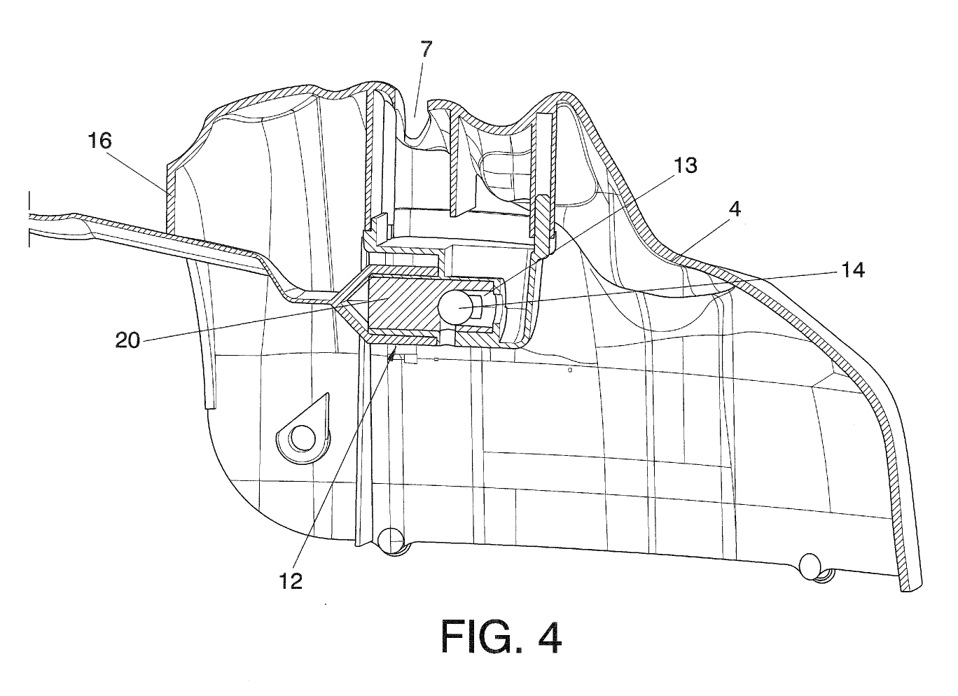

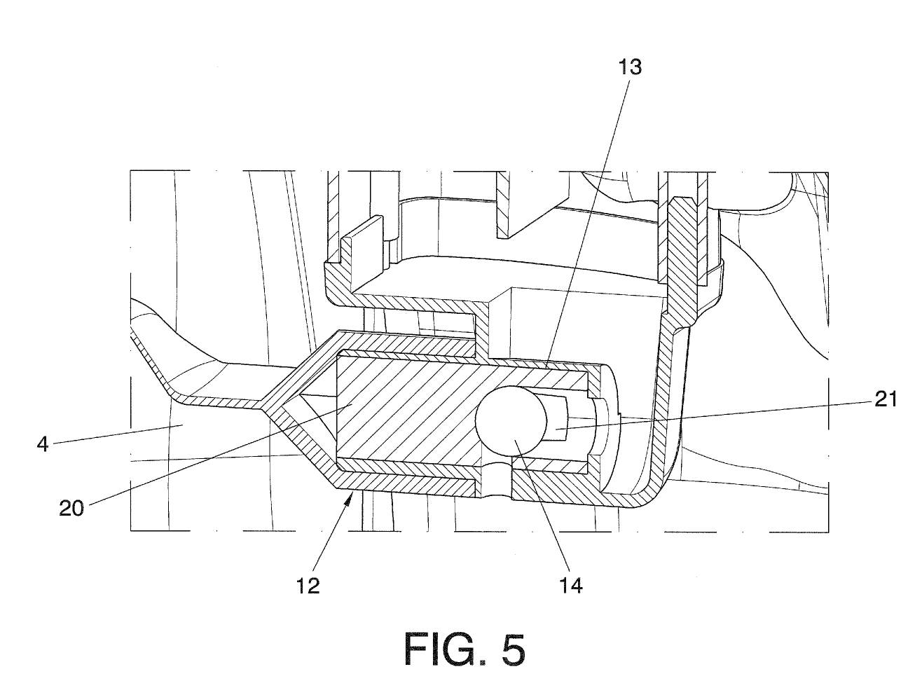

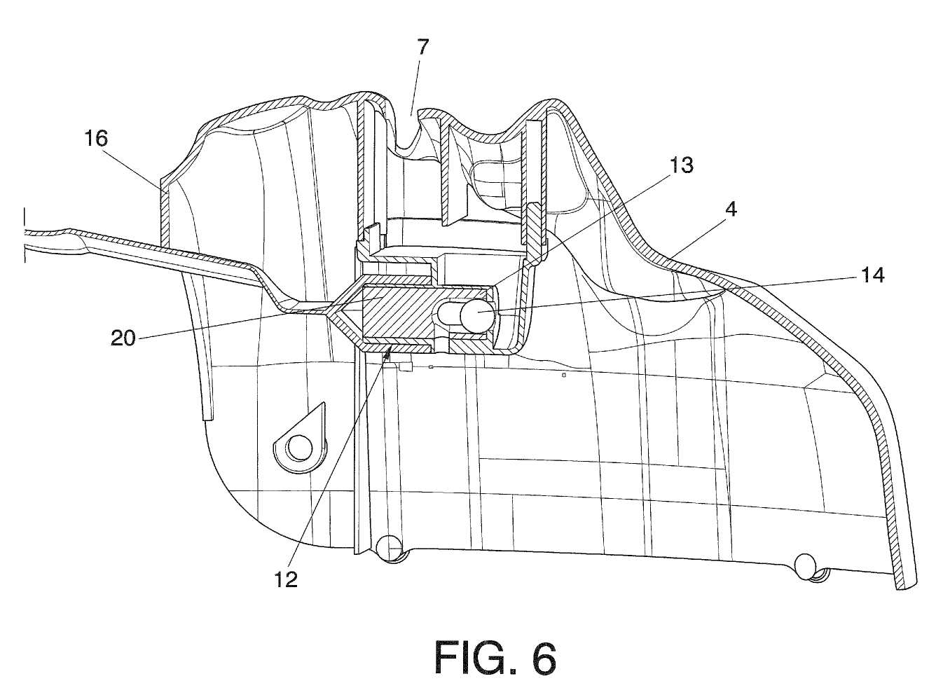

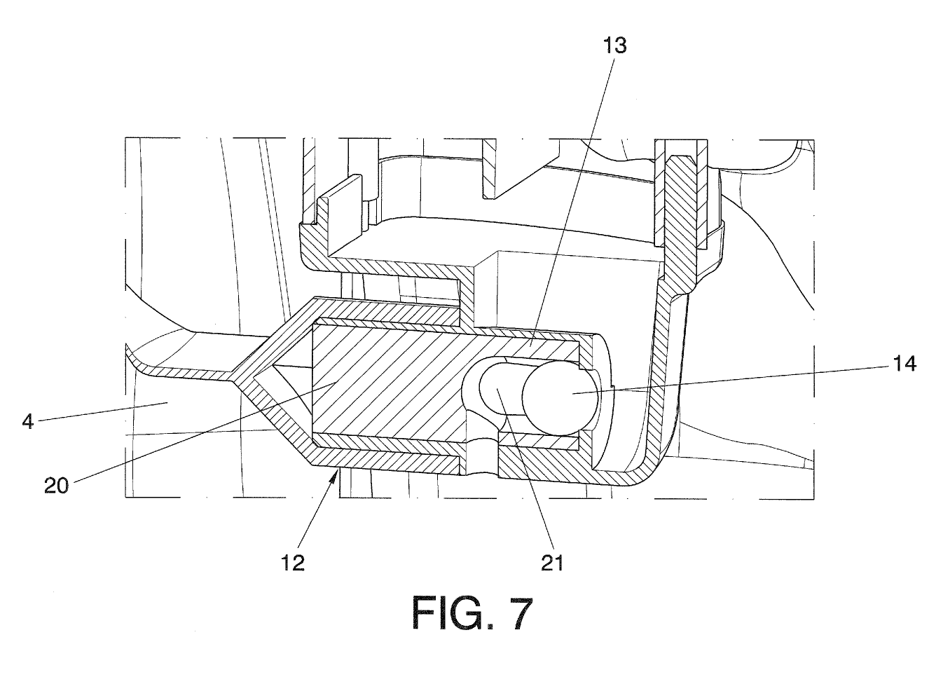

As can be seen in FIGS. 4 to 7, the head piece (4) is designed to occupy a resting position, FIGS. 4 and 5, in which it is kept substantially horizontal and the entrance of air into the bag through the orifices (6, 7) is prevented by a ball (14) comprised in the valve (13), and an active position, FIGS. 6 and 7, in which it is inclined backwards and the ball (14) of the valve (13) allows the entrance of air into the bag through said orifices (6, 7).

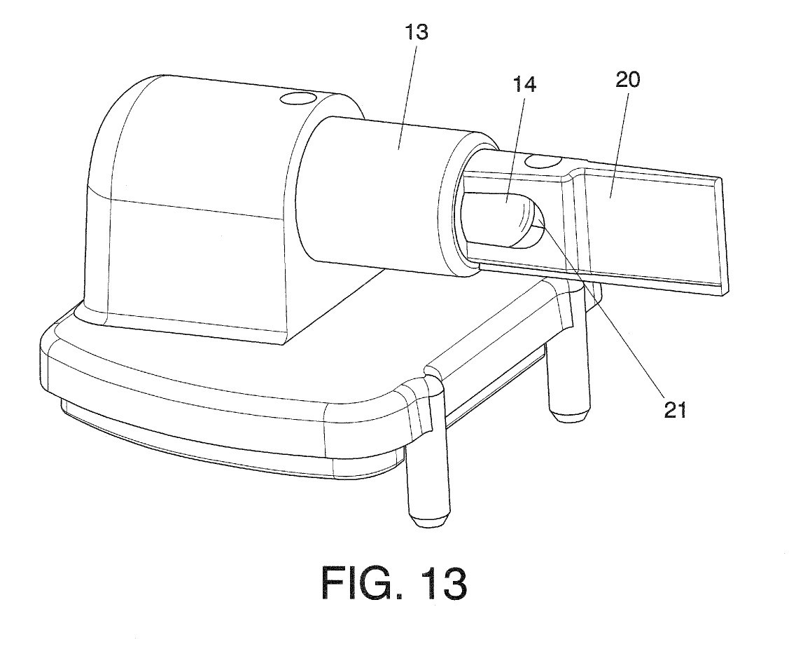

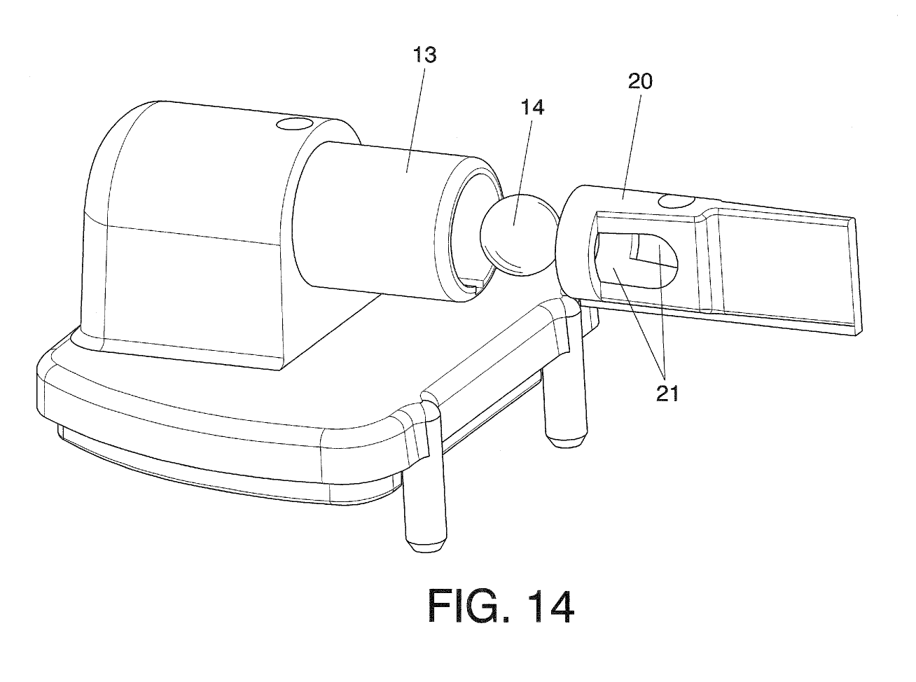

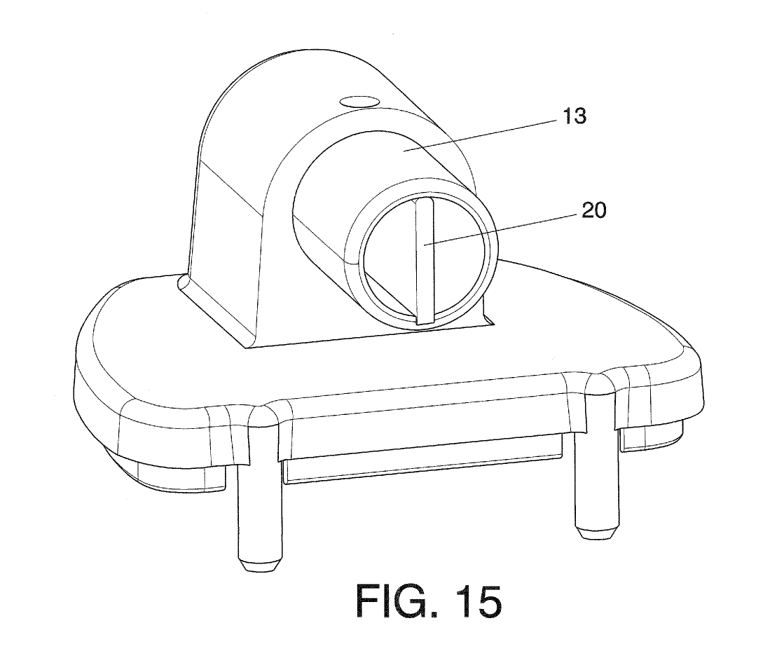

As can be seen in FIGS. 13 to 15, as well as in FIGS. 5 and 7, the valve (13) comprises a passage piece (20) which is inserted into said valve (13) for channeling the passage of air between the bag and the orifices (6, 7).

Said passage piece (20) contains the ball (14) and has respective side grooves (21) allowing the passage of air through the valve (13) depending on the position of said ball (14) in accordance with a narrowing of said passage piece (20) towards the area of connection with the bag.

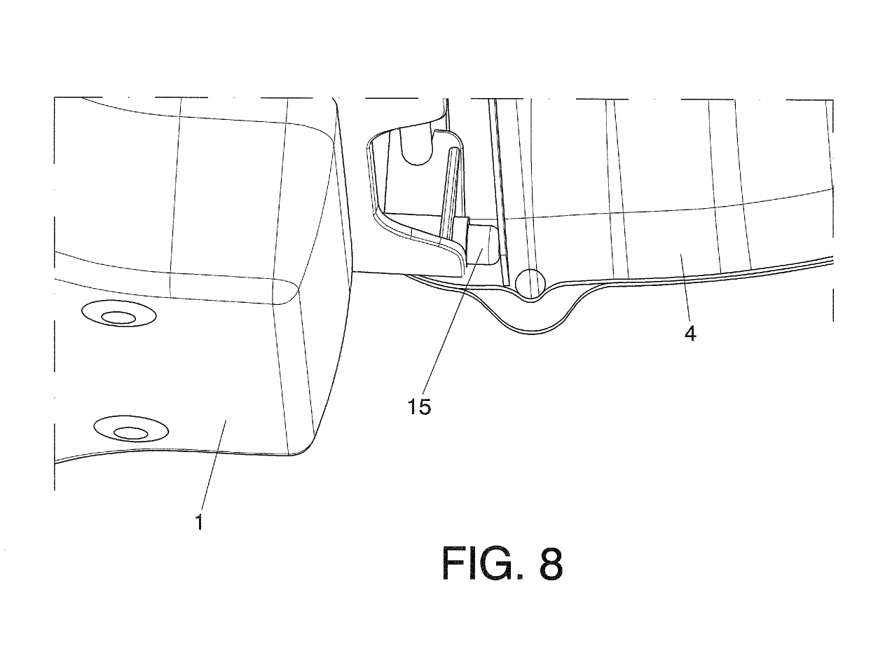

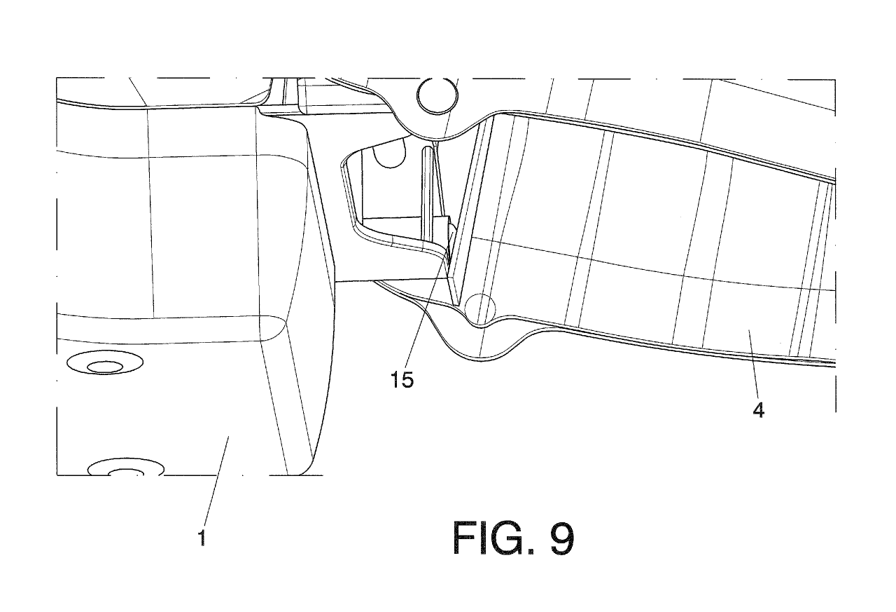

It can be seen in FIGS. 8 and 9 how the device comprises actuation means (15) by way of springs which permanently act on the head piece (4), specifically on flanges located in the inner face of the head piece (4), tending to move and keep said head piece (4) in the resting position when the actuation from a user is not received.

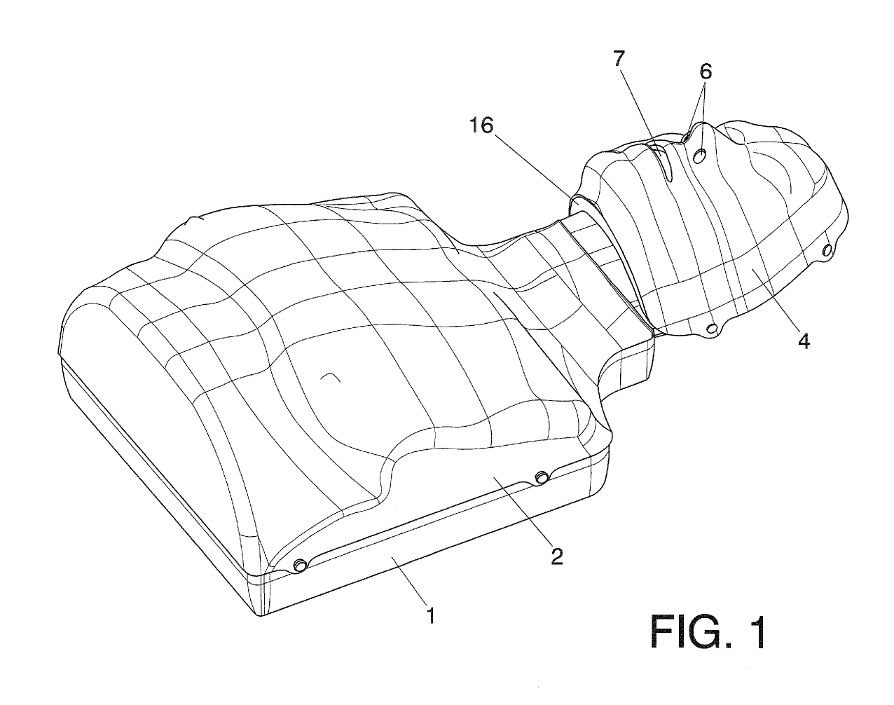

The closing wall (16) comprising the head piece (4) and its location as a lower prolongation preventing access to the inside of the head piece (4) from the area of the neck corresponding to the area of the chest piece (2) can be seen in FIG. 1.

In view of this description and set of drawings, the person skilled in the art will be able to understand that the embodiments of the invention which have been described can be combined in multiple ways. The invention has been described according to preferred embodiments thereof, but it will be obvious for the person skilled in the art that multiple variations can be introduced in said preferred embodiments.

1. Device for simulating cardiopulmonary resuscitation techniques comprising:
a base which is coupled to a chest piece in a shape of a human thorax and is designed to be elastically deformed towards the base when pressure is placed thereon by a user,
a hollow space existing between said base and said chest piece, wherein an upper end of the base is articulated to a head piece in a partial shape of a human face,
a pressure adjustment piece located in a central area of the base the plan projection of which corresponds with an area where pressure is applied for cardiopulmonary resuscitation,
wherein said pressure adjustment piece is designed to occupy a first position, in which at least an upper height stop limits the deformation of the chest piece when pressure is placed thereon, a second position, in which at least one lower height stop limits the deformation of the chest piece when pressure is placed thereon, the limit deformation of the chest piece in said second position being greater than the limit deformation in the first position, and a third position, in which the deformation of the chest piece is not limited by stops.

2. Device for simulating cardiopulmonary resuscitation techniques according to claim 1, wherein each upper height stop prolongs into an upper pivot and each lower height stop prolongs into a lower pivot, said lower pivot and upper pivot being designed to be alternatively housed in at least one guide prolonging from an inner face of the chest piece.

3. Device for simulating cardiopulmonary resuscitation techniques according to any of claim 2, wherein the head piece has two nasal orifices and a buccal orifice, the device comprising a lung-shaped bag housed in the space existing between the base and the chest piece, which is coupled to said orifices by means of a coupling device located in the inner face of the head piece, comprising a valve channeling an entrance of air into the bag from the nasal orifices and the buccal orifice and allowing expelling said air from the bag through an exit path different from said nasal orifices and said buccal orifice.

4. Device for simulating cardiopulmonary resuscitation techniques according to claim 3, wherein the head piece is designed to occupy a resting position in which it is kept substantially horizontal and the entrance of air into the bag through the orifices is prevented by a ball comprised in the valve, and an active position in which it is inclined backwards and the ball of the valve allows the entrance of air into the bag through said orifices.

5. Device for simulating cardiopulmonary resuscitation techniques according to claim 4, wherein the valve comprises a passage piece channeling the air between the bag and the orifices, wherein said passage piece contains the ball and has respective side grooves allowing the passage of air through the valve depending on the position of said ball.

6. Device for simulating cardiopulmonary resuscitation techniques according to claim 4, further comprising actuation means which permanently act on the head piece, tending to move and keep said head piece in the resting position when the actuation from a user is not received.

7. Device for simulating cardiopulmonary resuscitation techniques according to claim 1, wherein the head piece comprises a closing wall located as a lower prolongation preventing access to an inside of the head piece from an area of the neck corresponding to an area of the chest piece.
